(19) United States
(12) Patent Application Publication
(10) Pub. No.: US 2012/0268595 A1
(43) Pub. Date: Oct. 25, 2012

(54) REMOTE MONITORING APPARATUS AND METHOD THEREOF

(75) Inventor: SHAN-LIN CHOU, TAIPEI CITY (TW)

(73) Assignee: TAIWAN WELL GUARDER CO., LTD., TAICHUNG CITY (TW)

(21) Appl. No.: 13/450,552

(22) Filed: Apr. 19, 2012

(30) Foreign Application Priority Data
Apr. 20, 2011 (TW) 100113810

(51) Int. Cl. H04N 7/18

(52) U.S. Cl. 348/143; 348/E07.085

(57) ABSTRACT

The present invention provides a remote monitoring apparatus and method thereof. A short message sending unit is disposed in an image monitoring module used for detecting if the environment image is abnormal. When an abnormal environment image is detected, a corresponding monitoring message is produced. The short message sending unit produces an assigned short message according to the monitoring message produced by the image monitoring module and transmits the assigned short message to a short message server. The short message server then transmits the assigned short message to the corresponding mobile communication terminal via a network interface according to a user's name contained in the assigned short message. Accordingly, the present invention reduces the transmission platforms during the process a short message is sent from the image monitoring module to the mobile communication terminal, and thus reducing the delay of the short message and improving the efficiency of surveillance notification.

### FIELD OF THE INVENTION

The present invention relates generally to a monitoring apparatus and method thereof, and particularly to a remote monitoring apparatus and method thereof.

### BACKGROUND OF THE INVENTION

Nowadays, the public order is so deteriorating that the security industry forms for assisting the government to maintain the public security. In order to raise the value of security, security service providers provide varieties of services, such as remote monitoring. A general remote monitoring apparatus uses a local security host to control the anti-theft and video monitoring system. By means of telecommunication wires, the host is connected with the distant security control center set up privately and the alarm control panel in police stations. The programs in the security host can process various sensing signals, and then report cases automatically, remotely control video recording for evidence, and remotely guard entrance security.

Nonetheless, when the remote monitoring apparatus detects an abnormal situation, an alarm will be triggered, and the remote monitoring will be notified. Then the relevant personnel will be notified. The reality of an event cannot be judged until the relevant personnel arrives the site. In addition, if the remote monitoring apparatus is destroyed, even if the relevant personnel reach the site, what actually happened in the protected area is still unknown. In current video monitoring systems, the front-end photographic apparatus is a specific kind of equipment, such as a fixed camera, a hidden camera, or other photographic apparatuses. Besides, video conversion equipment, such as video server or IP camera, has to be used accordingly. Cameras supporting universal serial bus (USB) interface are widely used. Many video monitoring systems can be integrated with cameras having USB interface. Thereby, users can save substantial costs in purchasing video capture equipment of a remote monitoring system. Nevertheless, cameras having USB interface still need personal computers or specific host equipment, for example, embedded system host, for normal operations. Consequently, the objective of popularizing remote monitoring apparatuses is not easy to achieve.

Moreover, thanks to the rapid development of network technologies and the openness of the domestic communication market, especially to the rapid growth of the Internet, network utilization in domestic industrial and commercial fields and even personal users has become popular. Thereby, surveillance should not be limited to closed local applications. Instead, it should be integrated with the Internet. By taking advantage of the ever-reaching characteristic of the Internet, users' requirement in environmental surveillance can thus be satisfied. However, it is unavoidable that privacy can be an issue. If the monitoring space of a remote monitoring apparatus is in the bedroom and private space, when the user leaves the site, he is not able to completely control the operation of the remote monitoring apparatus. It is thereby impossible to turn on or off temporarily the photographic equipment. In addition, the video capture equipment adopted by a general remote monitoring apparatus does not have obvious light signals for labeling if the video capture is in operation or not. Furthermore, when a general remote monitoring apparatus detects an abnormal status, a management and control center first confirms the status. Then the signal is transmitted to a corresponding short message server. This process will threaten seriously users' privacy.

Besides, every monitoring module of a general remote monitoring apparatus transmits message via the management and control center. When the management and control center is abnormal or removed, the remote monitoring apparatus will be useless and the monitoring function for abnormal status can be performed. The management and control center needs to process if multiple monitoring modules produce abnormal statuses. Once the monitoring modules at different locations detect abnormal statuses and produce the corresponding monitoring signals, the management and control center needs to process according to the order the signals are produced. Consequently, the user of the remote monitoring apparatus is uncertain to know the abnormal status real-timely.

Accordingly, the present invention provides a remote monitoring apparatus and method thereof, which improve the problem in which notification of the remote monitoring apparatus according to the prior can be done only via the management and control center. Thereby, user' privacy is improved. Besides, the delay of the notification can be reduced as well.

### SUMMARY

An objective of the present invention is to provide a remote monitoring apparatus and method thereof, which reduce the transmission time from the monitoring end to the mobile communication terminal by adopting the notification method of outputting short messages directly to the short message server.

Another objective of the present invention is to provide a remote monitoring apparatus and method thereof, which uses the transmission technology of transmitting messages directly from the remote monitoring apparatus for avoiding the situation in which users cannot get the messages due to damages in the message management and control center.

The present invention provides a remote monitoring apparatus, which comprises an image monitoring module and a short message sending unit. The image monitoring module extracts an environment image according to a user's using environment and compares the environment image with a threshold image. When the image monitoring module detects an abnormal environment, it produces a monitoring message. The short message sending unit is connected electrically to the image monitoring module, and transmits an assigned short message to a short message server according to the monitoring message via the Internet. The short message server transmits the assigned short message to the corresponding mobile communication terminal according to a receiver name contained in the assigned short message via a network interface. Thereby, the remote monitoring apparatus according to the present invention transmits the monitoring result of an abnormal status to the user's mobile communication terminal by means of a short message sent directly from the image monitoring module. Hence, the notification delays caused by the management and control center can be reduced, and the privacy of messages can be kept as well.

The present invention further provides a remote monitoring apparatus, which uses a detecting unit connected electrically with the monitoring module and the short message sending unit for detecting an input/output status of the monitoring module. When the input/output status of the monitoring module is abnormal, the detecting unit produces and transmits a detecting message to the short message sending unit, so that the short message sending unit can produce an assigned short message according to the monitoring message and transmit the assigned short message to the short message server via the Internet. The short message server then transmits the assigned short message to the corresponding mobile communication terminal via a network interface according to a receiver name contained in the assigned short message. Thereby, privacy of message can be kept. Besides, excess transmission delay of the message can be avoided.

The present invention provides a remote monitoring method. The image monitoring module first extracts an environment image. Then whether the environment image is normal or not is detected according to a threshold image. When the image monitoring module detects that the environment image is abnormal, a corresponding monitoring message is produced. Next, a short message sending unit produces an assigned short message according to the monitoring message. The assigned short message is transmitted to a short message server via the Internet. The short message server then transmits the assigned short message to the corresponding mobile communication terminal via a network interface according to a receiver name contained in the assigned short message. Thereby, the remote monitoring apparatus according to the present invention transmits the monitoring result of an abnormal status to the user's mobile communication terminal by means of a short message sent directly from the image monitoring module. Hence, the notification delays caused by the management and control center can be reduced, and the privacy of messages can be kept as well.

The present invention provides a remote monitoring method. A detecting unit is first used for detecting electrically an input/output status of a monitoring module. When the input/output status of the monitoring module is abnormal, the detecting unit produces and transmits a detecting message to the short message sending unit, so that the short message sending unit can produce an assigned short message according to the monitoring message and transmit the assigned short message to the short message server via the Internet. The short message server then transmits the assigned short message to the corresponding mobile communication terminal via a network interface according to a receiver name contained in the assigned short message. Thereby, privacy of message can be kept. Besides, excess transmission delay of the message can be avoided.

### BRIEF DESCRIPTION OF THE DRAWINGS

FIG. 1A shows a block diagram according to a preferred embodiment of the present invention;

FIG. 1B shows a schematic diagram of the short message according to a preferred embodiment of the present invention;

FIG. 2 shows a flowchart according to a preferred embodiment of the present invention;

FIG. 3 shows a block diagram according to another preferred embodiment of the present invention;

FIG. 4 shows a block diagram according to another preferred embodiment of the present invention; and

FIG. 5 shows a flowchart according to another preferred embodiment of the present invention.

### DETAILED DESCRIPTION

In order to make the structure and characteristics as well as the effectiveness of the present invention to be further understood and recognized, the detailed description of the present invention is provided as follows along with embodiments and accompanying figures.

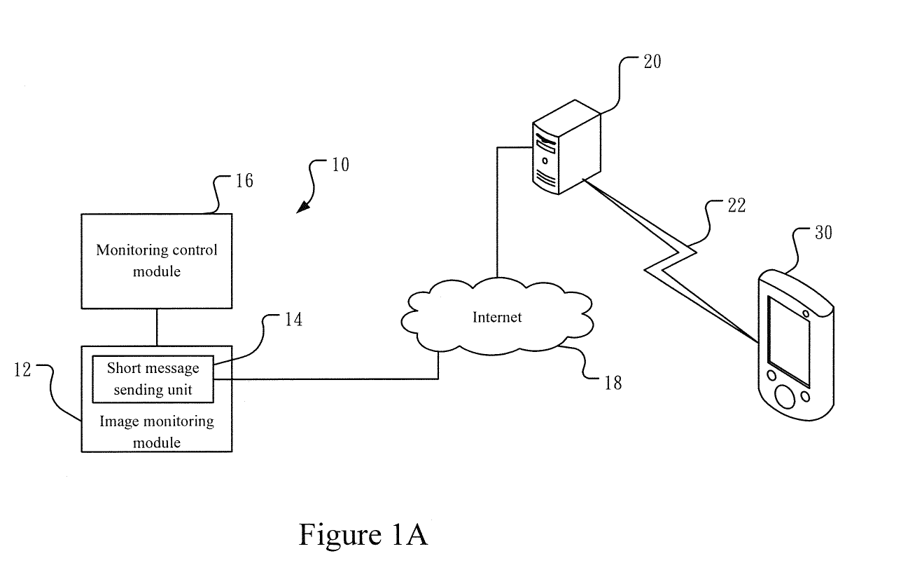

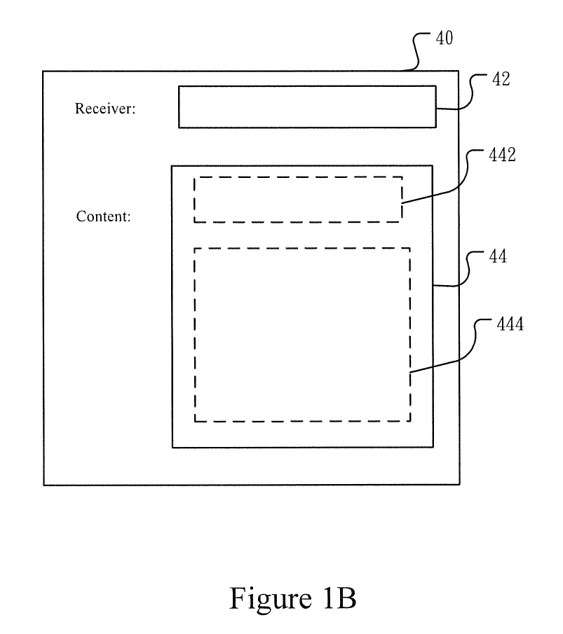

FIG. 1A shows a block diagram according to a preferred embodiment of the present invention. As shown in the figure, the remote monitoring apparatus 10 according to the present invention is disposed in a user's using environment, such as the domestic living room, the bedroom, or the working place. The remote monitoring apparatus 10 comprises an image monitoring module 12 and a short message sending unit 14. In addition, the remote monitoring apparatus 10 according to the present invention further comprises a monitoring control module 16.

The short message sending unit 14 is disposed in the image monitoring module 12. The short message sending unit 14 is connected to a short message server 20 via the Internet 18. The short message sending unit 14 according to the present embodiment is built in the image monitoring module 12 and is an embedded unit, which, in other words, is an embedded operating system or a non-multi-tasking simple operating system, such as the embedded Windows or Linux. Besides, the monitoring control module 16 is connected electrically to the image monitoring module 12.

The image monitoring module 12 monitors an environment and extracts an environment image of the environment. After the environment image is extracted, the image monitoring module 12 compares the environment image with a threshold image. When the image monitoring module 12 detects an abnormal status, it produces a monitoring message correspondingly. According to the present embodiment, the image monitoring module 12 a network camera for extracting and storing the environment image to the monitoring control module 12. In addition, the image monitoring module can further be a digital video recorder (DVR), which records an environment video and stores it to the monitoring control module 16. The image monitoring module 12 compares each frame of the environment video with a threshold image. When an abnormal frame is detected, the image monitoring module 12 produces and transmits a video monitoring message to the short message sending unit 14 according to the abnormal frame. Nonetheless, the present invention is not limited to this application. The image monitoring unit 12 can further be a digital camera supporting USB for extracting images. The short message sending unit 14 transmits an assigned short message to the short message server 20 according to the monitoring message. The short message server 20 transmits the assigned short message to the corresponding mobile communication terminal 30 according to a receiver name 42 contained in the assigned short message 40, as shown in FIG. 1B. The mobile communication terminal 30 according to the present embodiment is a mobile phone. Besides, the mobile communication terminal 30 according to the present invention can further receive the assigned short message 40 according to a mobile instant messaging protocol. Thereby, the mobile communication terminal 30 according to the present invention can receive the assigned short message by means of the message service provided by a mobile application program (APP). Moreover, the monitoring control module 16 controls the image monitoring module 12 to extract the environment image.

Refer to FIG. 1B. The content of the assigned short message 40 includes a receiver's name 42 and a short message content 44. The receiver's 42 is the mobile phone number of the user of the remote monitoring apparatus 10. The short message content 44 according to the present embodiment further includes an alarm type 442 and a network address 444. The alarm type 442 is the type corresponding to the abnormal status, for example, monitoring module damage or intrusion. The network address 444 is network address corresponding to the image monitoring module 12. Thereby, the user can connect to the image monitoring module 12 via the network address 444 attached in the short message 40 and get the monitoring status of the image monitoring module 12. Nonetheless, the present invention is not limited to this application. The short message sending unit 14 can further transmit only the network address 44 to the user's mobile communication terminal 30. Besides, the short message sending unit 14 can further send an email corresponding to the short message 40 to the user's email box. Namely, the email is sent to the corresponding email box of the mobile communication terminal 30 for preventing the situation when the mobile communication terminal 30 does not receive or cannot open the link of the network address 444.

Consequently, when the image monitoring module 12 of the remote monitoring apparatus 10 according to the present invention detects the abnormal environment image, unlike the remote monitoring apparatus according to the prior art, it is not necessary to transmit the corresponding monitoring message of the abnormal status to the remote management and control center first. Thereby, when the management and control center is not operating, the short message of the abnormal status still can be transmitted to the user's mobile communication terminal. In addition, because it is not required to forward messages to the management and control center, the communication between the remote monitoring apparatus 10 and the mobile communication terminal 30 is direct, and hence the speed for sending the short message of abnormal status is faster than the remote monitoring apparatus according to the prior art. Furthermore, the short messages need not to pass the management and control center. Thereby, the user needs not to worry leakage of his privacy during the transmission process via the management and control center.

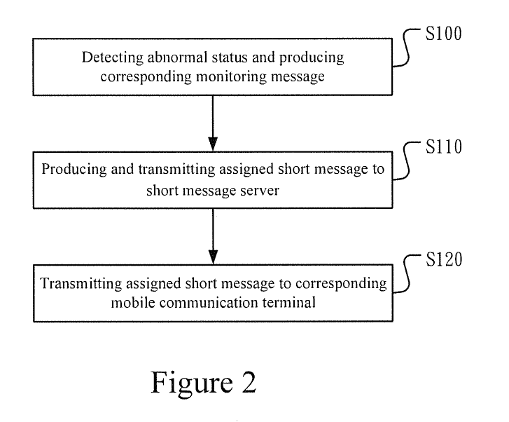

FIG. 2 shows a flowchart according to a preferred embodiment of the present invention. As shown in the figure, the steps of the method for remote monitoring comprise:

Step S100: Detecting an abnormal status and producing a corresponding monitoring message;

Step S110: Producing and transmitting an assigned short message to a short message server; and

Step S120: Transmitting the assigned short message to the corresponding mobile communication terminal.

In the step S100, an image monitoring module detects an abnormal image and produces a corresponding monitoring message. The image monitoring module monitors an environment and extracts an environment image of the environment. After the environment image is extracted, the image monitoring module compares the environment image with a threshold image. When the abnormal image is detected, the image monitoring module produces the monitoring message. In the step S110, a short message sending unit produces an assigned short message according to the monitoring message and transmits the assigned short message to a short message server. The short message sending unit transmits the assigned short message to the short message server via the Internet. In the step S120, the short message server transmits the assigned short message to the corresponding mobile communication terminal according to a receiver's name contained in the assigned short message via a network interface, such as the Internet or a communication network. In addition, the mobile communication terminal according to the present invention can further receive the assigned short message by executing a mobile application program (APP) and according to a mobile instant messaging protocol.

According to the present invention, it is not required to forward messages through the management and control center. Thereby, the speed of transmitting the short message of an abnormal status by the remote monitoring apparatus according to the present invention is faster than that according to the prior. Besides, transmission of short message does not need to pass the management and control center. Hence, users need not to worry about leakage of privacy in the short messages during the transmission process.

As described above, the short message sending unit 14 sends short messages to the short message server 20 through the Internet 18. Accordingly, the short message sending unit 14 connects to the Internet via the optical-fiber network, the asymmetric digital subscriber line (ADSL), or the integrated service digital network (ISDN) for transmitting short messages to the short message server 20. The network interface 22 described above is a communication network connecting the short message server 20 and the mobile communication terminal 30. Besides, the short message server 20 can be connected with the mobile communication terminal 30 through the Internet 18.

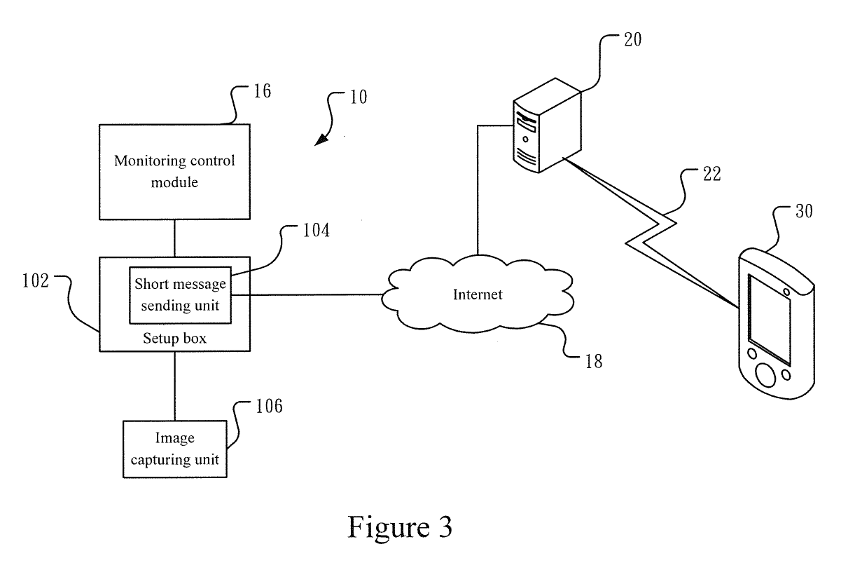

FIG. 3 shows a block diagram according to another preferred embodiment of the present invention. The difference between FIG. 2 and FIG. 3 is that the remote monitoring apparatus 10 according to FIG. 3 includes a setup box 102, a short message sending unit 104, and at least an image capturing unit 106 for image monitoring. The short message sending unit 104 is disposed in the setup box 102. The image capturing unit 106 is connected with the setup box 102. The image capturing unit 106 connected with the setup box 102 is similar to the image monitoring module 12 described above; the short message sending unit 104 is similar to the short message unit 14. Hence, their functions will not be repeated again here. As shown in the figure, in addition to producing a corresponding monitoring signal when the image monitoring module detest an abnormal environment image, the remote monitoring apparatus 10 according to the present invention can accomplish image monitoring by further adopting the setup box 102, the short message sending unit 104, and the image capturing unit 106. The image capturing unit 106 can transmit the extracted image to the setup box 102 via the communication protocols such as USB, IEEE1394, RS486, and RS232.

Accordingly, the present invention can be further applied to multimedia application equipment such as the setup box 102. By adding the short message sending unit 104 and connecting to the image capturing unit 106, the purpose of real-timely notifying a user using an assigned short message can be achieved, and thus improving real-time message notification and privacy. In addition, the situation of inability in notifying the user when abnormality occurs by using centralized management in a management and control center can be prevented.

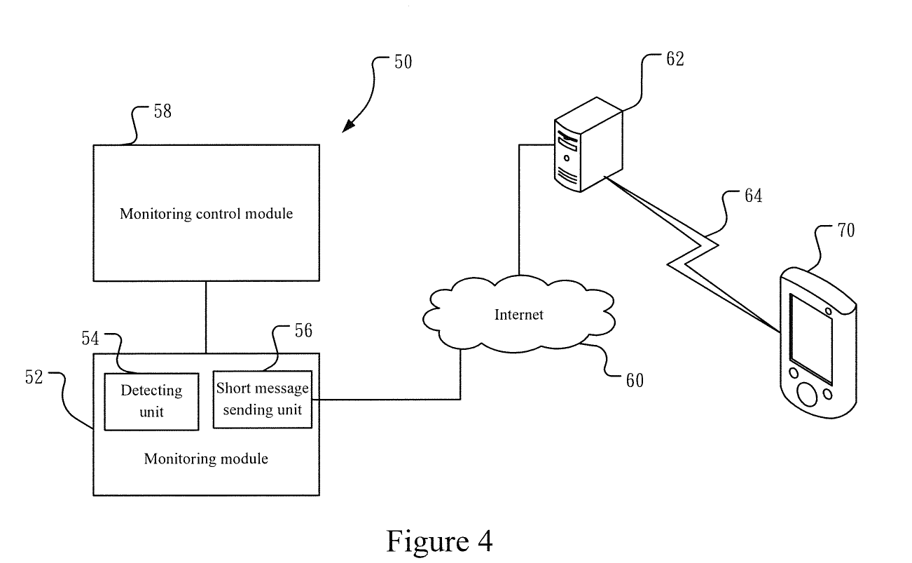

FIG. 4 shows a block diagram according to another preferred embodiment of the present invention. The difference between FIG. 3 and FIG. 4 is that the remote monitoring apparatus 10 in FIG. 3 performs short-message notification according to the abnormal result of image monitoring by the image monitoring module 12, while the remote monitoring apparatus 50 in FIG. 4 does it according to the abnormal input/output status detected by a detecting unit 54. As shown in the figure, the remote monitoring apparatus 50 according to the present invention comprises a monitoring module 52, the detecting unit 54, and a short message sending unit 56. Besides, the remote monitoring apparatus 50 further comprises a monitoring control module 58.

The detecting unit 54 and the short message sending unit 56 are disposed in the monitoring module 52. The detecting unit 54 detects if the input/output status of the monitoring module 52 is normal. When the detecting unit 54 detects that the input/output status of the monitoring module 52 is abnormal, it produces and transmits a detecting message short-message sending unit 56, which, then, produces an assigned short message according to the detecting message and transmits the assigned short message to a short message server 62 through the Internet 60. The short message server 62 transmits the assigned short message to a mobile communication terminal 70 via a network interface 64 according to the receiver's name 42 contained in the assigned short message (as shown in FIG. 1B). According to the present embodiment, the detecting unit 54 detects various input/output statuses of the monitoring module. Nonetheless, the present invention is not limited to detecting the input/output statuses of the image monitoring module; the present invention can further detects, for example, fire monitoring module, earthquake monitoring module, and radiation monitoring module.

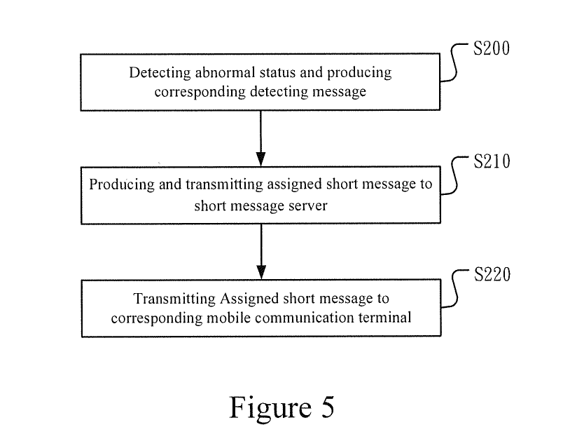

FIG. 5 shows a flowchart according to another preferred embodiment of the present invention. As shown in the figure, the steps of the method for remote monitoring comprise:

Step S200: Detecting an abnormal status and producing a corresponding detecting message;

Step S210: Producing and transmitting an assigned short message to a short message server; and

Step S220: Transmitting the assigned short message to the corresponding mobile communication terminal.

In the step S200, when a detecting unit detects an input/output status of a monitoring module, if an abnormal status of the input/output status is detected, the detecting unit produces a corresponding detecting message. In the step S210, a short message sending unit produces an assigned short message according to the detecting message and transmits the assigned short message to a short message server. The short message sending unit transmits the assigned short message to the short message server via the Internet. In the step S220, the short message server transmits the assigned short message to the corresponding mobile communication terminal according to a receiver's name 42 contained in the assigned short message (as shown in FIG. 1B) via a network interface, such as the Internet or a communication network.

According to the present invention, it is not required to forward messages through the management and control center. Thereby, the speed of transmitting the short message of an abnormal status by the remote monitoring apparatus according to the present invention is faster than that according to the prior. Besides, transmission of short message does not need to pass the management and control center. Hence, users need not to worry about leakage of privacy in the short messages during the transmission process.

As described above, the short message sending unit sends short messages to the short message server through the Internet. Accordingly, the short message sending unit connects to the Internet via the optical-fiber network, ADSL, or ISDN for transmitting short messages to the short message server. The network interface described above is a communication network connecting the short message server and the mobile communication terminal. Besides, the short message server can be connected with the mobile communication terminal through the Internet. In addition, the mobile communication terminal according to the present invention can further connect to the short message server by executing a mobile application program for receiving the assigned short message via the interface provided by the mobile application program.

To sum up, the present invention provides a remote monitoring apparatus and method thereof. First, the monitoring module monitors a using environment of a user. When an abnormal status of detected, a corresponding monitoring message is produced for the short message sending unit to produce and transmit the corresponding short message according to the monitoring message to the short message server. Then the short message can be transmitted directly to the user's mobile communication terminal, such as a mobile phone. Thereby, the present invention improves real-time message notification and privacy. Besides, by the situation of inability in notifying the user when abnormality occurs by using centralized management in a management and control center can be prevented.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. A remote monitoring apparatus, comprising:
an image monitoring module, extracting an environment image, comparing said environment image according to a threshold image, and producing a corresponding monitoring message when said image monitoring module judges that said environment image is abnormal; and
a short message sending unit, disposed in said image monitoring module, transmitting an assigned short message to a short message server according to said monitoring message via the Internet, and said short message server transmitting said assigned short message to a corresponding mobile communication terminal via a network interface according to a user's name contained in said assigned short message.

2. The remote monitoring apparatus of claim 1, and further comprising a monitoring control module, connected to said image monitoring module, controlling said image monitoring module to extract said environment image, and controlling said short message sending unit to transmit said assigned short message to said short message server.

3. The remote monitoring apparatus of claim 1, wherein said network interface is a communication network or the Internet.

4. The remote monitoring apparatus of claim 1, wherein said assigned short message further comprises a network address of said image monitoring module.

5. The remote monitoring apparatus of claim 1, wherein said mobile communication terminal receives said assigned short message according to a mobile instant messaging protocol.

6. A method for remote monitoring, comprising steps of:
extracting an environment image to an image monitoring module;
using said image monitoring module to compare said environment image according to the previous environment image, and producing a monitoring message when said environment image is detected abnormal;
using a short message sending unit to produce an assigned short message according to said monitoring message and transmit said assigned short message to a short message server via the Internet; and
said short message server transmitting said assigned short message to a corresponding mobile communication terminal via a network interface according to a receiver's name contained in said assigned short message.

7. The method for remote monitoring of claim 6, where said network interface is a communication network or the Internet.

8. The method for remote monitoring of claim 6, wherein said assigned short message further comprises a network address of said image monitoring module.

9. The method for remote monitoring of claim 6, wherein said mobile communication terminal receives said assigned short message according to a mobile instant messaging protocol.

10. A remote monitoring apparatus, comprising:
a monitoring module, monitoring an environment;
a detecting unit, detecting an input/output status of said monitoring module, and producing a detecting message when said input/output status of said monitoring module is abnormal; and
a short message sending unit, connected electrically with said detecting unit, transmitting an assigned short message to a short message server according to said detecting message via the Internet, and said short message server transmitting said assigned short message to a corresponding mobile communication terminal via a network interface according to a user's name contained in said assigned short message.

11. The remote monitoring apparatus of claim 10, and further comprising a monitoring control module, connected to said monitoring module and said detecting unit, controlling said monitoring module to monitor the status of said environment, controlling said detecting unit to detect said input/output status, and controlling said short message sending unit to transmit said assigned short message to said short message server.

12. The remote monitoring apparatus of claim 10, wherein said assigned short message further comprises a network address of said monitoring module.

13. The remote monitoring apparatus of claim 10, wherein said mobile communication terminal receives said assigned short message according to a mobile instant messaging protocol.

14. A method for remote monitoring, comprising steps of:
using an detecting unit to detect an input/output status of a monitoring module, and said detecting unit producing a detecting message when said input/output status is detected abnormal;
using a short message sending unit to produce an assigned short message according to said detecting message and transmit said assigned short message to a short message server via the Internet; and
said short message server transmitting said assigned short message to a corresponding mobile communication terminal via a network interface according to a receiver's name contained in said assigned short message.

15. The method for remote monitoring of claim 14, where said network interface is a communication network or the Internet.

16. The method for remote monitoring of claim 14, wherein said assigned short message further comprises a network address of said monitoring module.

17. The method for remote monitoring of claim 14, wherein said mobile communication terminal receives said assigned short message according to a mobile instant messaging protocol.
